(19) United States
(12) Patent Application Publication
(10) Pub. No.: US 2012/0284991 A1
(43) Pub. Date: Nov. 15, 2012

(54) CONFIGURABLE PORT FITMENT, KIT, AND RELATED METHODS

(76) Inventors: Matthew Kusz, Bloomington, MN (US); Vishwas Pethe, Shakopee, MN (US)

(21) Appl. No.: 13/514,365

(22) PCT Filed: Dec. 7, 2010
(86) PCT No.: PCT/US10/59253

§ 371 Date: Jun. 7, 2012

Related U.S. Application Data
(60) Provisional application No. 61/267,263, filed on Dec. 7, 2009.

(51) Int. Cl. F16K 51/00; B23P 17/04

(52) U.S. Cl. 29/428; 137/315.01

(57) ABSTRACT

A configurable port fitment includes an adapter for forming a locking engagement with a connector associated with a vessel. A kit and related methods may use the configurable port fitment.

This application claims the benefit of U.S. Provisional Patent Application Ser. No. 61/267,263, filed Dec. 7, 2009, the disclosure of which is incorporated herein by reference.

### TECHNICAL FIELD

This disclosure relates generally to fluid processing and, more specifically, to a configurable port fitment for a vessel, a kit, and related methods.

### BACKGROUND OF THE INVENTION

Fluid processing applications typically employ vessels for at least temporarily receiving and containing the fluid. For example, in the course of bioprocessing, hermetically sealed bags formed of flexible plastic film are often used for bulk intermediate storage, cell culture re-suspension, viral inactivation, final formulation, final fill, or as bioreactors. In any case, such vessels or bags almost universally include one or more ports for use in operations such as introducing or withdrawing a fluid via a length of tubing, powder charging, or receiving probes or sampling units.

Oftentimes, different applications or users of such vessels dictate different requirements for the ports. This leads to the production of various types of fitments adapted for the particular purpose for which the associated port is used. In the past, manufacturers of the vessels either awaited an order before manufacturing the fitments, or stockpiled quantities of vessels having the most common types and sizes of fitments in anticipation of possible future customer needs. As can be appreciated, neither practice is considered particularly efficient or effective from a cost standpoint. Fitments may also require expensive and time-consuming manufacturing techniques, both of which further detract from efficiency.

Thus, a need is identified for a manner of providing an improved port fitment for a vessel, such as a mixing bag. The fitment would be capable of use in addressing a variety of different requirements for the vessels, and would also be relatively easy to create and implement. Overall, use of the fitment would thus lead to a simplification of the manufacturing process and a concomitant reduction in the expense associated with manufacturing vessels, such as flexible bags.

### SUMMARY OF THE INVENTION

One aspect of the disclosure relates to an apparatus for forming a port fitment. The apparatus comprises an unsterilized vessel having an interior compartment adapted for receiving a fluid, said vessel including a connector including a first wall forming a port and having a first locking element. A first adapter including a first portion adapted for insertion in the interior of the first wall, said first adapter having a passage adapted for transmitting the fluid to or from the vessel via the port and including a second locking element adapted for forming a locking engagement with the first locking element.

Preferably, the second locking element is within the port, and the first locking element is provided within the port. The apparatus may further include a second adapter having a third locking element adapted for forming a locking engagement with the first locking element of the connector. Most preferably, the second adapter and the first adapter are different in at least one characteristic.

The first locking element may comprise at least one projection and the second locking element may comprise a receiver, or vice-versa. In one embodiment, the projection comprises an annular bead for engaging the receiver in snap-fit engagement. In other embodiments, one of the first or second locking elements comprise one of at least two projections and at least two receivers. The projections may comprise lugs and the receivers comprise channels (which may include at least one segment extending in an axial direction along the connector and at least one segment extending in a circumferential direction along the connector, whereby the lug and channel create a bayonet fitting). Alternately, at least two projections of the first locking element comprise flexible aims, each having an end adapted for positioning in one of the receivers. Still as another alternative, at least two projections of the second locking element comprise arms projecting axially from a peripheral ledge of the connector.

In another embodiment, the first locking element comprises a removable fastener and the second locking element comprises an aperture for receiving the fastener. Alternately, the first locking element comprises a cup-shaped receiver including an opening defining a ledge, and the second locking element comprises a shoulder having a periphery oversized relative to the opening and forming a notch for engaging the ledge. Still further, the first locking element may comprise an inwardly flared flexible projection depending from the first wall and the second locking element comprises a shoulder having a periphery oversized relative to the opening and forming a notch for engaging the projection. In this and other embodiments, the adapter may include a peripheral projection for engaging an upper surface of the first wall when the notch engages the projection. The first locking element may comprise a thread, in which case the second locking element comprises a matching thread.

A first end of the adapter may include a first barb. A second barb may be provided on a second end of the adapter. The first and second barbs may be adapted for engaging different sizes of tubing.

In yet another embodiment, the first wall of the connector includes a side opening and a top opening exposing the port. The adapter may in such case be configured for insertion through the side opening of the first wall. The adapter preferably comprises a tubular passage communicating with a side drain adapted to receive fluid from a space formed by the first wall, as well as at least one alignment tab for engaging the side opening in the first wall. Most preferably, the at least one alignment tab is offset from the first locking element in a circumferential direction. Also, the wall may be frusto-conical and project toward an interior compartment of the vessel.

In any of the embodiments, a seal may be provided for sealing the adapter to the connector. The seal may comprise an O-ring positioned on one of the adapter or connector, such as within a circumferential groove. Also, the connector may comprise a boat-shaped structure. The mating portions of the adapter and connector may have matching cross-sectional shapes selected from the group consisting of circular, oval, polygonal, and cross-shaped. The vessel may comprise a bag, in which case the adapter and connector are more rigid than the bag. The connector may include a plurality of ports, and the apparatus may thus include an adapter for engaging each of the ports (which may number three or more and be arranged in a substantially linear row). The adapter may also include crenellations, and project at least partially beyond a base of the connector and into the interior compartment of the vessel. The adapter may include a peripheral projection having a diameter greater than the diameter of the port. Preferably, one of the first or second locking elements is adapted for permanently deforming as the result of disengagement with the other of the first or second locking elements. A fluid-agitating element for positioning in the vessel may also be provided.

Another aspect of the disclosure pertains to an apparatus for forming a fitment on a vessel, comprising an adapter including a structure selected from the group consisting of a barb adapted for connecting with a tubing, a valveless plug for sealing the port of the connector, and a tubular fitting adapted for charging the vessel with powder or receiving a probe. The apparatus includes a connector adapted for connecting to the vessel and including a port. First and second locking elements are provided for forming a locking engagement between the connector and the adapter, wherein the first locking element and second locking element, respectively, are selected from the group consisting of: (a) at least one removable fastener and an aperture for receiving the fastener; (b) a projection and a shoulder having a periphery that is oversized and including a notch for engaging the projection; (c) at least one lug and a channel adapted for receiving the lug; (d) at least two arms and a corresponding receiver for receiving an end of each of the arms; and (e) notches for receiving the ends of at least two arms projecting axially from a peripheral ledge of the connector.

A related aspect of the disclosure is an apparatus for forming a port fitment, comprising an unsterilized vessel adapted for receiving a fluid, said vessel including a connector forming a tubular port, and a first adapter adapted for being inserted into the tubular port in an insertion direction so as to form a snap-fit engagement with the connector such that movement opposite a direction of insertion is prevented. Preferably, the adapter projects at least partially through the port into an interior compartment of the vessel, and may include a peripheral projection having a diameter greater than the diameter of the port for positioning external to the port.

Still a further aspect of the disclosure relates to an apparatus for associating with a vessel, comprising: a connector adapted for attachment to the vessel and having a port, said connector further including a wall adjacent the port, said wall defining a side opening and a top opening, and an adapter including a first locking element for forming a locking engagement with the connector. The adapter may be configured for insertion through the side opening of the wall. Preferably, the adapter comprises a tubular passage communicating with a side drain port adapted to receive fluid from a space formed by the wall, and may include at least one alignment tab for engaging the side opening in the wall. Preferably, the at least one alignment tab is offset from the first locking element in a circumferential direction. The wall may be frusto-conical and project towards an interior compartment of the vessel.

Yet a further aspect of the disclosure relates to an apparatus for forming a port fitment on a vessel, comprising a connector adapted for connection to the vessel, said connector having an elongated, generally upstanding sidewall forming a tubular port, and a first adapter including a first portion adapted for insertion in the interior of the tubular port. At least a first part of the first portion of the adapter has an outer diameter greater than an inner diameter of at least a portion of the sidewall of the connector. Preferably, at least the second part of the first portion of the adapter has an outer diameter greater than the inner diameter of the portion of the sidewall of the connector. A sealing element may also be provided for forming a seal between the adapter, and wherein the adapter includes a first locking element for forming a locking engagement with a second locking element of the connector.

Another aspect of the disclosure relates to an apparatus for forming a port fitment on a vessel, comprising a connector adapted for connection to the vessel, said connector having an elongated, generally upstanding sidewall forming a tubular port and including an inwardly flared, flexible projection, and a first adapter including a first portion adapted for insertion in the interior of the tubular port and having an oversized shoulder adapted for engaging the inwardly flared, flexible projection.

This disclosure also relates to an apparatus for forming a port fitment on a vessel, comprising a connector adapted for connection to the vessel, said connector having an elongated, generally upstanding sidewall forming a tubular port including a first locking element, and a first adapter including a first portion adapted for insertion in the interior of the tubular port and a second, generally concentric second portion, said first and second portions forming a receiver, and one of said first or second portions including a second locking element for forming a locking engagement with the first locking element.

Also disclosed is an apparatus for forming a port fitment, comprising a vessel having an interior compartment adapted for receiving a fluid under sterile conditions, said vessel including a connector having a first locking element. A first adapter includes a second locking element connected to the first locking element of the connector to form a locking engagement, such that breaking the locking engagement deforms one or the first or second locking elements in a manner that prevents use under sterile conditions. Preferably, the locking elements are selected from the group consisting of: (a) at least one removable fastener and an aperture for receiving the fastener; (b) a projection and a shoulder having a periphery that is oversized and including a notch for engaging the projection; (c) at least two arms and a corresponding receiver for receiving an end of each of the arms; and (d) notches for receiving the ends of at least two arms projecting axially from a peripheral ledge of the connector.

A kit is also disclosed for forming a port fitment on a vessel including a connector having a generally upstanding sidewall forming a tubular port and including first locking element. The kit comprises a plurality of tubular adapters, each including a first portion adapted for insertion in the interior of the tubular port and including a second locking element for forming a locking engagement with the first locking element of the connector. Each adapter includes a first locking element for engaging a second locking element of the corresponding connector, wherein the first locking element and second locking element, respectively, are selected from the group consisting of: (a) at least one removable fastener and an aperture for receiving the fastener; (b) a projection and a shoulder having a periphery that is oversized and including a notch for engaging the projection; (c) at least one lug and a channel adapted for receiving the lug; (d) at least two arms and a corresponding receiver for receiving an end of each of the arms; and (e) notches for receiving the ends of at least two arms projecting axially from a peripheral ledge of the connector.

Also forming part of the disclosure is a method of forming a sterilized vessel for an end user. The method comprises providing an unsterilized vessel including a connector having a port; forming a locking engagement between the adapter and the connector; and then, prior to delivery to the end user, sterilizing the vessel with the adapter associated with the connector. Preferably, the connector includes a plurality of ports, and the method further includes the step of positioning a different adapter in each port of the connector. The connector may include a first locking element for engaging a second locking element of the adapter to form the locking engagement, and further including the step of disengaging the locking elements such that one of the adapter or the connector cannot form the locking engagement again.

### BRIEF DESCRIPTION OF THE DRAWING FIGURES

FIG. 1 is a schematic view of one possible embodiment of a vessel with a configurable port fitment;

FIGS. 1a-1d illustrate a first embodiment of a port fitment;

FIGS. 2a and 2b illustrate a second embodiment of a port fitment;

FIGS. 3a and 3b illustrate a third embodiment of a port fitment;

FIGS. 4a and 4b illustrate a fourth embodiment of a port fitment;

FIGS. 5a and 5b illustrate a fifth embodiment of a port fitment;

FIGS. 6a and 6b illustrate a sixth embodiment of a port fitment;

FIGS. 7a and 7b illustrate a seventh embodiment of a port fitment;

FIGS. 8a and 8b illustrate an eighth embodiment of a port fitment;

FIGS. 9a-9f illustrate a ninth embodiment of a port fitment;

FIG. 10 illustrates a tenth embodiment of a port fitment;

FIGS. 11a-11b illustrate an eleventh embodiment of a port fitment;

FIGS. 12a-12c illustrate a twelfth embodiment of a port fitment;

FIGS. 13a and 13b illustrate a thirteenth embodiment of a port fitment;

FIGS. 14a and 14b illustrate a fourteenth embodiment of a port fitment;

FIGS. 15a-15d illustrate a fifteenth embodiment of a port fitment;

FIG. 16 illustrates a sixteenth embodiment of a port fitment;

FIGS. 17a and 17b illustrate a seventeenth embodiment of a port fitment;

FIGS. 18a-18c illustrate an eighteenth embodiment of a port fitment;

FIG. 19 illustrates a nineteenth embodiment of a port fitment; and

FIGS. 20a-20c illustrate a twentieth embodiment of a port fitment.

### DETAILED DESCRIPTION OF THE ILLUSTRATED EMBODIMENTS

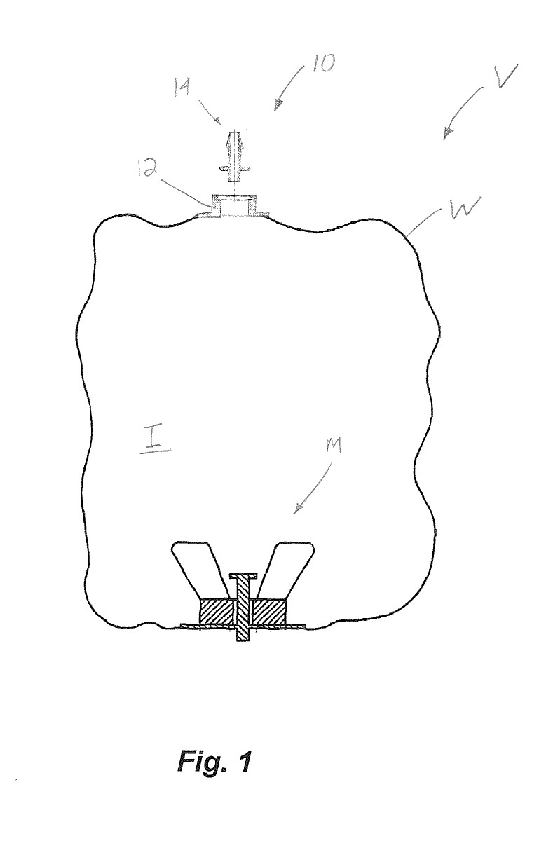

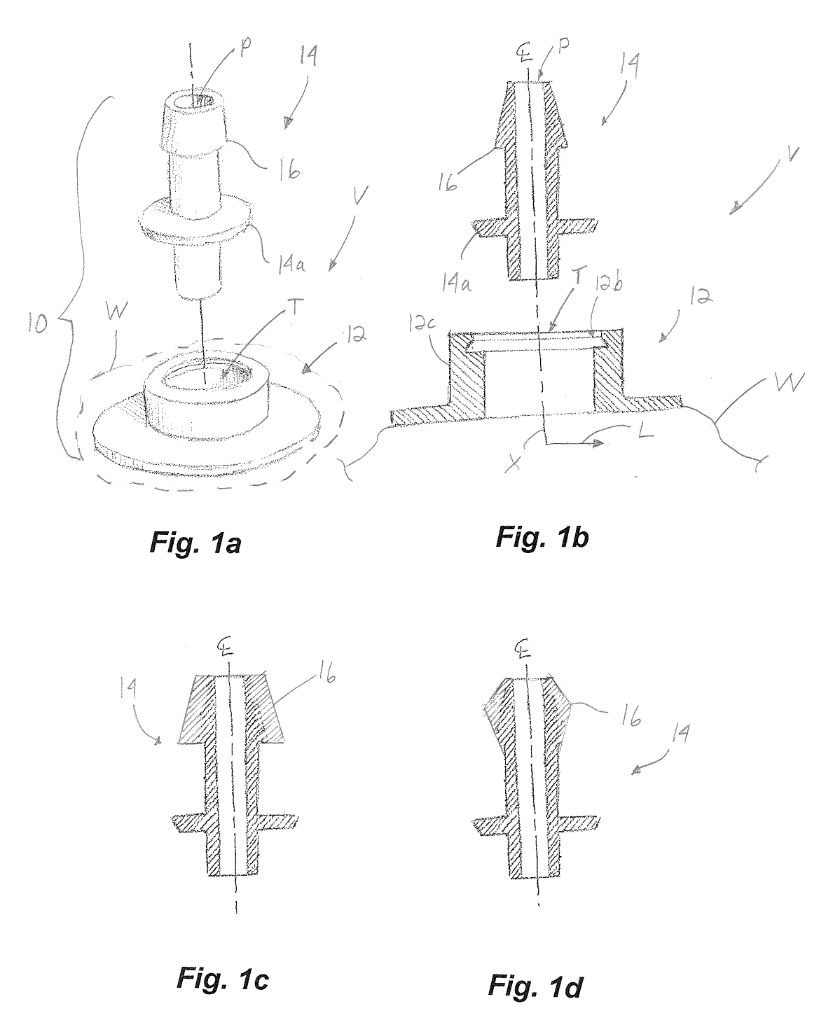

Reference is now made to FIG. 1, which illustrates a configurable port fitment 10 for a vessel V according to one aspect of the disclosure. Preferably, this vessel V is of the type used in processing fluids under sterile conditions, such for preparing biological agents, pharmaceutical preparations, or the like (including but not limited to bulk intermediate storage, cell culture re-suspension, viral inactivation, final formulation, final fill, or as a bioreactor/fermenter). In the most preferred embodiment, the vessel V comprises at least one wall W made of a thin, flexible, plastic film, which means it can be folded and, when filled, may adapt to the shape dictated by the fluid in the interior compartment I. This is distinguished from a rigid material that, although capable of flexing under significant force, generally does not change shape as the result of fluid being introduced into the vessel V.

The vessel V may also include an agitator, which may comprise any type of rotatable or non-rotatable stirrer, but preferably one that is capable of agitating the fluid under sterile conditions. For example, this element may comprise a magnetic impeller M adapted to form a non-contact coupling with a motive device external to the vessel V, thereby avoiding the need for dynamic seals or like structures that can create issues in terms of maintaining sterility. Alternatively, a rotatable sleeved mixer may be introduced into the interior compartment I and driven by a motor external to the interior compartment. A sparger (not shown) or other device could be used instead of or in addition to impeller M to provide a level of fluid agitation as well as promoting gas exchange with any liquid in the interior compartment.

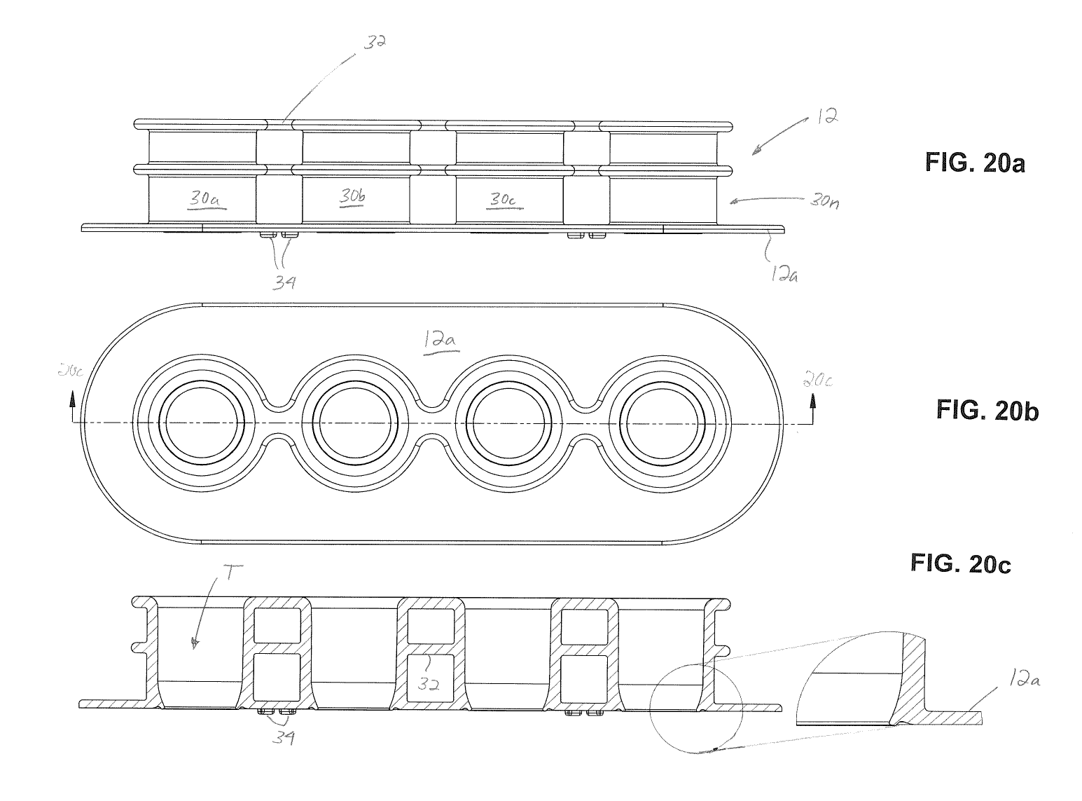

With continued reference to FIG. 1, as also referring now to FIGS. 1a and 1b, the fitment 10 includes a connector 12 having a port T and configured for forming a locking engagement with an adapter 14. For purposes of this disclosure, a locking engagement is one in which the two parts mechanically interface, and is contrasted with a friction fit or interference fit. The connector 12 is preferably formed of a like material as the vessel V, such as plastic, and is most preferably more rigid than the material forming the wall W. A peripheral extension, such as a flange 12a (which may be disc-shaped, as shown, but may take other forms; see FIGS. 20a-20c), is also provided along the connector 12 for being connected to the wall W, either along an inner surface or an outer surface. The connection may be made by welding or any other type of attachment, such that, with the exception of port T, a fluid-impervious seal is formed between the connector 12 and the corresponding vessel V.

The adapter 14 includes a tubular passage P capable of transmitting a fluid. Preferably, the adapter 14 is configured for a particular use for which port T is desired. For example, the adapter 14 preferably extends outside of the interior compartment I and includes a coupler, such as barb 16, at one end for engaging an open end of a length of tubing. The preferred form of the adapter 14 is also elongated in the axial direction X, and thus has a proportionately smaller diameter in a transverse or lateral direction L.

In accordance with one aspect of the disclosure, the adapter 14 includes a first locking element for forming a locking engagement with the connector 12 to form the configurable fitment 10. In one embodiment, as shown in FIG. 1b, the locking element for the adapter 14 includes a peripheral projection 14a in the form of a flange. As can be understood from the drawing, this flange forming the projection 14a in this embodiment is oversized relative to a recess 12b formed along the interior of an upstanding wall 12c at least partially defining the port T in the connector 12. The recess 12b forms a ledge, such as via an annular groove, and the projection 14a includes a corresponding mating edge. Consequently, manually pressing the projection 14a serving as the locking element of the adapter 14 into engagement with e recess 12b and ledge together forming a matching locking element of the connector 12 forms a snap-fit engagement.

Using this structural arrangement, it is advantageously possible to provide multiple adapters 14 having different characteristics and adapted for different uses, but similarly configured to mate with the connector 12 using a reliable locking engagement. For example, as shown in FIG. 1e and compared to FIG. 1b, the adapter 14 may include a coupler, such as frusto-conical barb 16, that is larger in size (length or diameter). As FIG. 1d shows, the adapter 14 may have a coupler, such as barb 16, of a different shape.

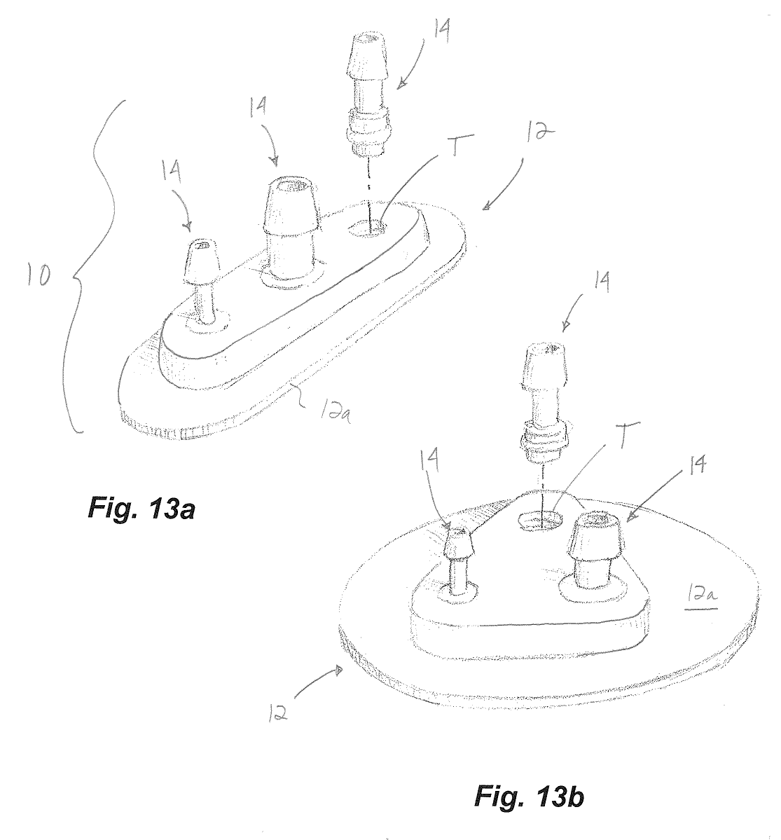

In view of the manner in which the connection is established, and as outlined further in the description that follows, the vessel V may be associated with one of many different adapters to accommodate the needs of a particular customer. This association may occur during the manufacturing process, before delivering the vessel V including the connector 12 to the customer (such as in a clean room environment), or even on site at the time of use. A retrofit onto a vessel with an existing connector 12 matching with the particular adapter 14 is also possible, or it may be possible to replace an existing adapter with another one matching the connector. In any of these cases, the vessel V may thus be manufactured in an unsterilized condition with the connector 12 and open port T (as shown in FIG. 1), and then associated with the selected adapter 14 (or adapters 14; see FIGS. 13a and 13b). The locking engagement may be manually established, and thus the need for welding or like mechanical processes for forming a permanent connection may be avoided. The adapter 14 may then be sealed (such as by using a clamp or piece of tubing with a closure or sterile filter; not shown), and the assembly sterilized for later use under sterile conditions. This way, the vessel V can be adapted just-in-time for a particular use, if desired, and the need for stockpiling various types of vessels with different fitments to meet customer requirements may be eliminated.

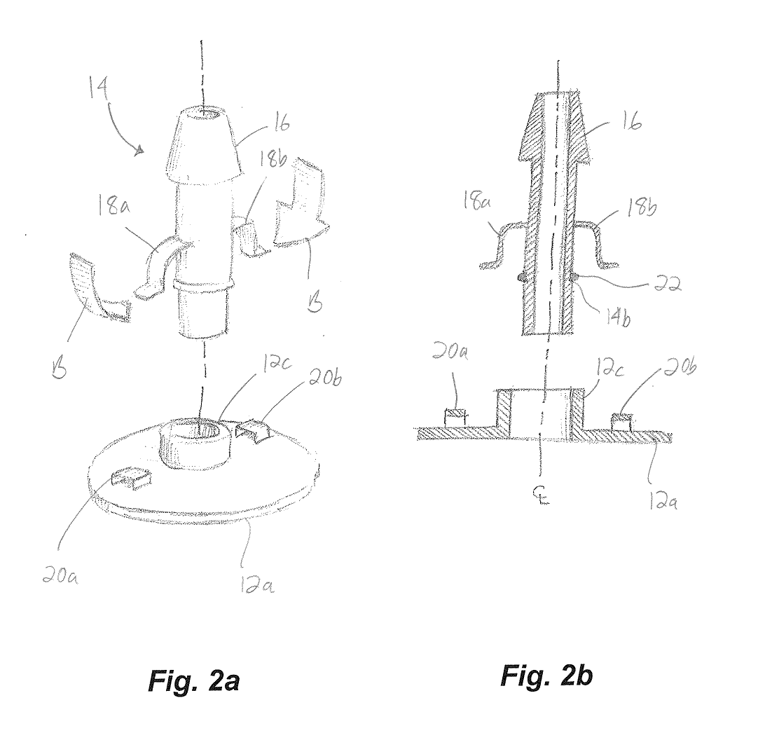

Various other embodiments of interchangeable adapters 14 to create the configurable port 10 are also contemplated. For example, FIGS. 2a and 2b show an embodiment in which the first locking element for the adapter 14 comprises a peripheral locking element comprising at least two projections in the form of arms 18a, 18b. The arms 18a, 18b in this embodiment extend generally in the radial direction. The free ends of these arms 18a, 18b are adapted for insertion in receivers 20a, 20b that may form the second locking element of the connector 12. These receivers 20a, 20b may be formed on a planar face of the connector 12, adjacent the wall 12c defining the port T. The arms 18a, 18b may be sufficiently flexible such that they may be bent inwardly toward the body of the adapter 14 (note action arrows B) prior to insertion in the connector 12 and then released afterwards, such that the inherent spring action urges the free ends into locking engagement with the receivers 20a, 20b.

The connector 12 and adapter 14 in this embodiment mate in sealing engagement. This may be achieved by providing a sealing element, such as a gland or gasket. Preferably, the sealing element comprises an elastomeric O-ring 22, which may be positioned in an annular groove 14b formed on the adapter 14. Most preferably, the sealing element is provided at a different location from the place where the locking engagement occurs, such that the seal is established independent of the locking engagement. Alternatively, and as will be understood from reviewing the description that follows, the sealing element, such as O-ring, may be provided on the connector 12. The sealing element may be removable, as shown, or may be integrally formed with the connector 12 or adapter 14. In any case, the arrangement preferably forms a sterile barrier between the ambient environment and an interior compartment I.

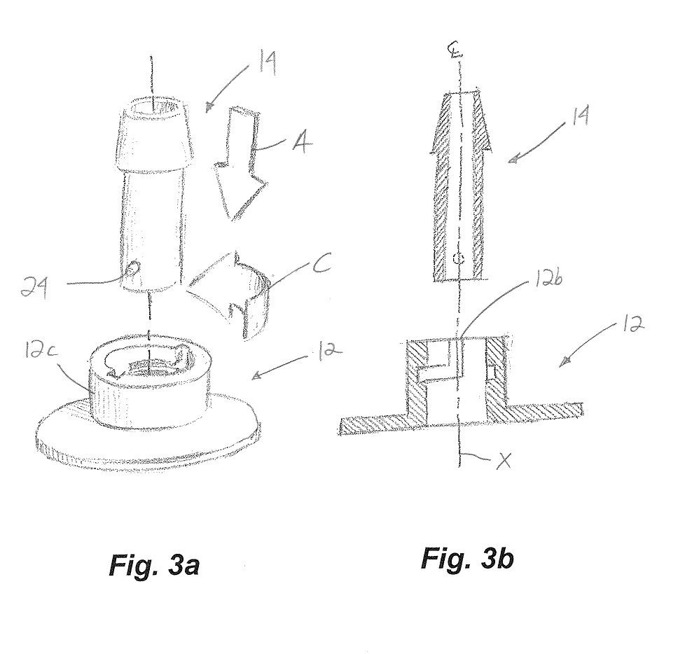

Another embodiment of the locking engagement in the nature of a bayonet fitting is shown in FIGS. 3a and 3b. In the illustrated configuration, the adapter 14 includes a peripheral locking element including at least two projections in the nature of a pair of opposing lugs, which extend in opposite radial directions (only one lug 24 shown in FIG. 3a). A corresponding recess 12b in the connector 12 forms a channel adapted for receiving each lug 24. Specifically. a first segment of each channel includes an open end along a ledge of the wall 12c for receiving the lug 24 in an axial direction X. A second segment at the opposite end of the first segment extends in a circumferential direction, preferably about 90°. Thus, referring back to FIG. 3a, the adapter 14 may be inserted into the port T defined by the connector 12 in the axial direction (action arrow A), and then rotated in the circumferential direction (action arrow C) to establish the locking engagement. A sealing element (not shown) may also be provided.

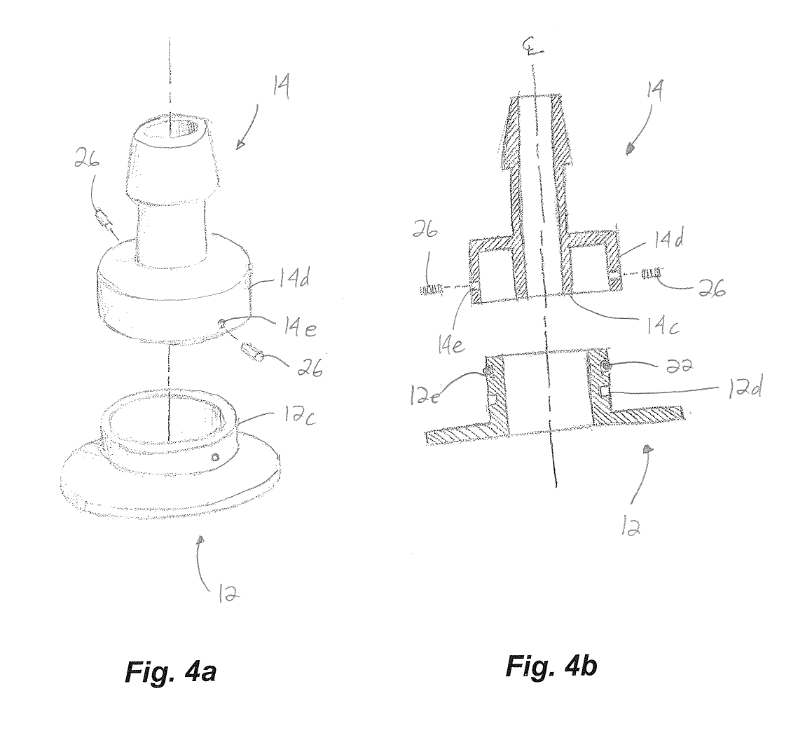

FIGS. 4a and 4b illustrate another embodiment in which the adapter 14 includes concentric inner and outer walls 14c and 14d. The inner wall 14c includes an outer diameter that is less than the inner diameter of the wall 12c of the connector 12, and the outer wall 14d has an inner diameter that is greater than the outer diameter of the wall 12c. Thus, the adapter 14 essentially covers the wall 12c in the mated position for forms a receiver (annular, in this embodiment) for receiving this wall 12c. To achieve the locking engagement, a first locking element, such as a removable fastener 26 (e.g., a dowel, set screw, pin, or the like) may engage a second locking element of the adapter 14, such as by inserting the fastener 26 peripherally through apertures 14e in the outer wall 14d for positioning in corresponding receivers 12d in the connector 12. To create a fluid-tight engagement, a corresponding sealing element, such as O-ring 22, may seat in a groove 12e formed in the connector 12, and mate with a corresponding surface on the adapter 14.

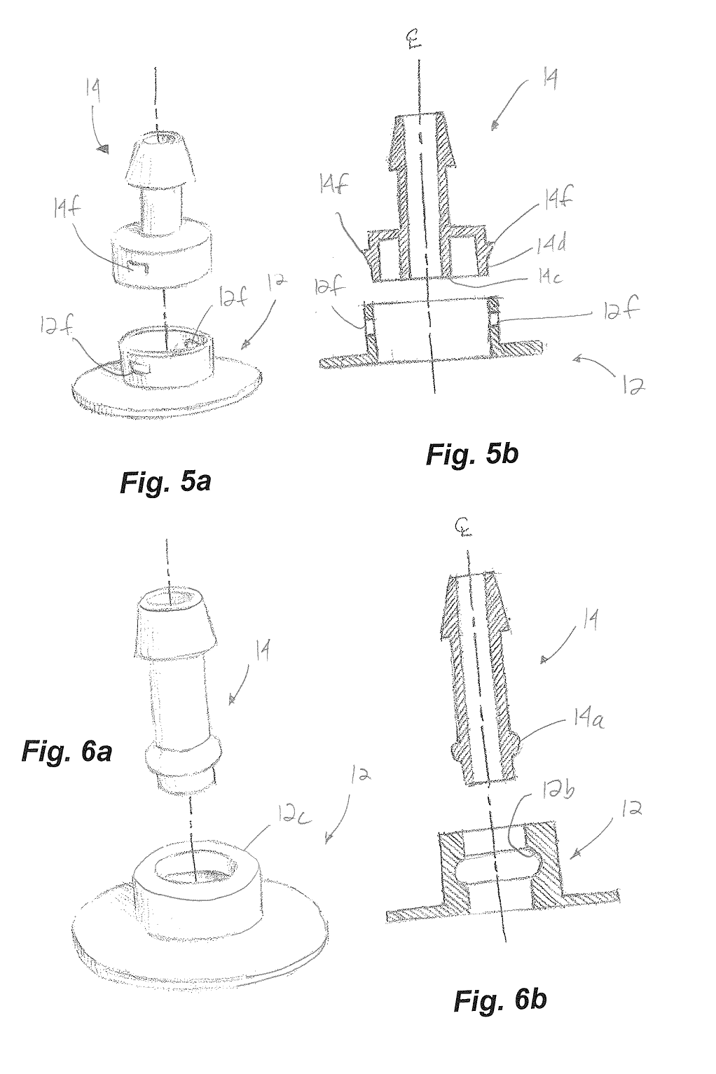

In the embodiment of FIGS. 5a and 5b, the adapter 14 is constructed similarly in terms of the concentric outer and inner walls 14c, 14d. The outer wall 14d here includes a locking element comprising at least two peripheral projections in the form of tabs 14f for engaging corresponding locking elements of the connector 12, such as apertures 12e formed in the wall 12c. Preferably, the tabs 14f are chamfered to form a ledge for engaging the upper surface of the wall 12c inside each aperture 12f. Thus, upon insertion of the adapter 14 into the connector 12 in the axial direction, the tabs 14f may align and register with the apertures 12f to establish the locking engagement (which may be made fluid tight with an appropriate sealing element).

FIGS. 6a and 6b illustrate an alternate embodiment in which the adapter 14 includes a peripheral projection 14a in the form of an annular bead. A corresponding annular recess 12b formed along the inner surface of the wall 12c is adapted to engage the bead when the corresponding end of the adapter 14 is inserted in the port T of the connector 12. The engagement may form a snap-fit.

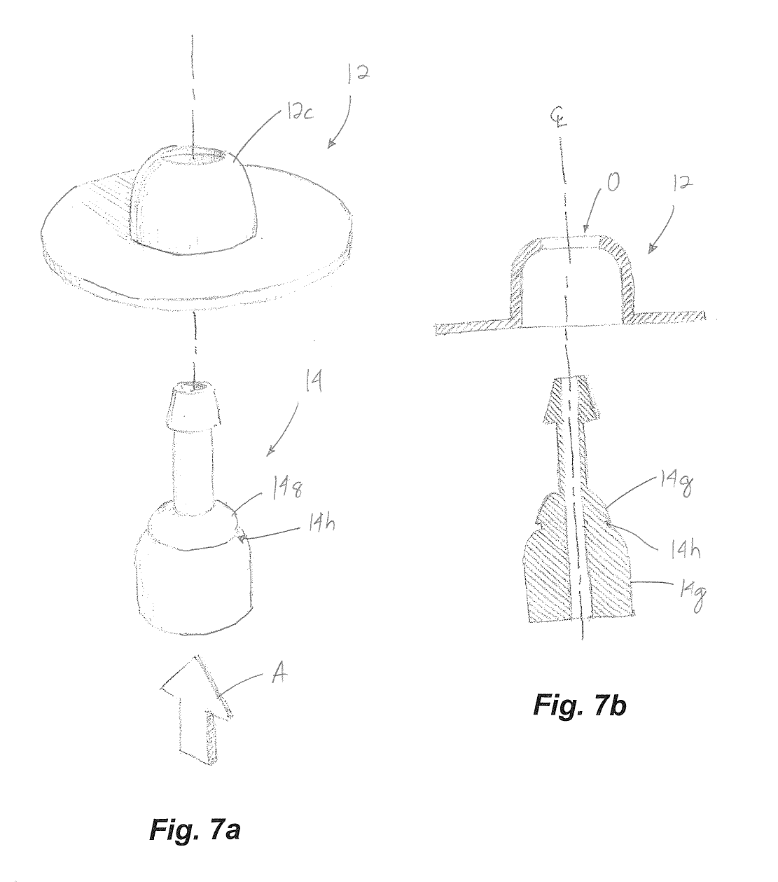

A further embodiment of the fitment 10 in FIGS. 7a and 7b involves arranging the wall 12c of the connector 12 to form a cup-shaped receiver adapted for nesting with the adapter 14 in locking engagement. Specifically, in the illustrated embodiment, the wall 12c defines an opening O as part of port T, but rather than being regular as in FIGS. 1a and 1b, the wall curves radially inward to define an annular ledge. The second locking element corresponding to the ledge comprises a shoulder 14g on the adapter 14 having a periphery that is at least partially oversized relative to this opening O, except along a narrower nose portion sized to freely pass through it. The adapter 14 further includes an annular notch 14h along the oversized portion of the shoulder 14g and adapted for fully engaging the ledge formed by the upper end of the wall 12c. Thus, when the adapter 14 is inserted into the receiver of the connector 12 in the axial direction, as shown in FIG. 7a (action arrow A), the locking engagement is established (possibly with a sealing element).

It should be further appreciated in this embodiment that the adapter 14 is installed from the side of the connector 12 that will face the interior compartment I of the vessel V. Thus, when the connector 12 has already been associated with the vessel V, it will be necessary to leave an opening to permit the adapter 14 to be inserted (such as in the case of a bag, through a gap between two ends of the flexible film that will eventually be connected, such as by welding, to form a seam). Upon establishing the locking engagement, sealing and sterilization of the vessel V may proceed with the adapter 14 in place and sealed in the desired fashion. The engagement may be as shown in FIG. 7a before the connector 12 associates with the vessel V.

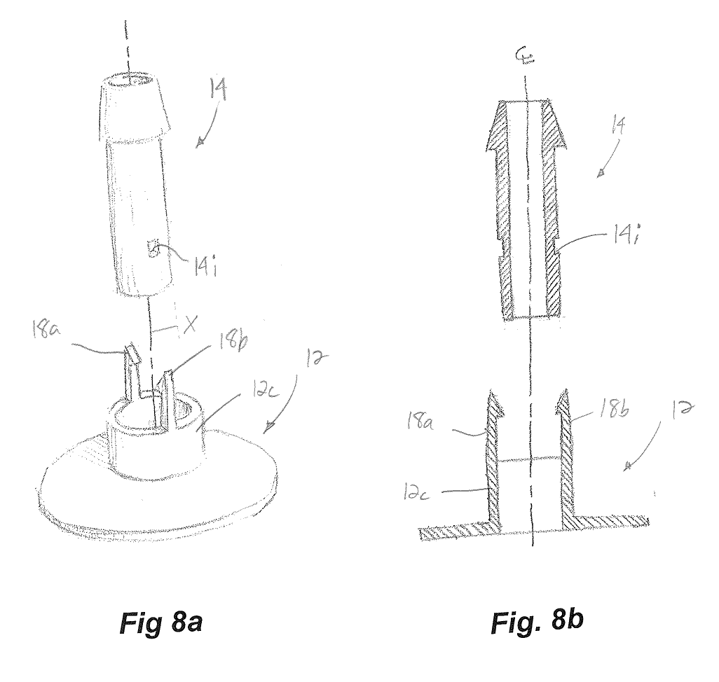

The embodiment of FIGS. 8a and 8b includes a connector 12 with a wall 12c having a ledge, from which at least two generally parallel arms 18a, 18b extend in the axial direction X. The arms 18a, 18b are generally offset 180° and include radial projections extending inwardly. These projections are adapted to mate with notches 14i formed at a corresponding location in the outer surface of the adapter 14 (which is sized along the end opposite barb 16 to have an outer diameter that is less than the inner diameter of wall 12c). Thus, the adapter 14 may be inserted into the connector 12 to place the projections of arms 18a, 18b in the notches 14i to form the desired locking engagement.

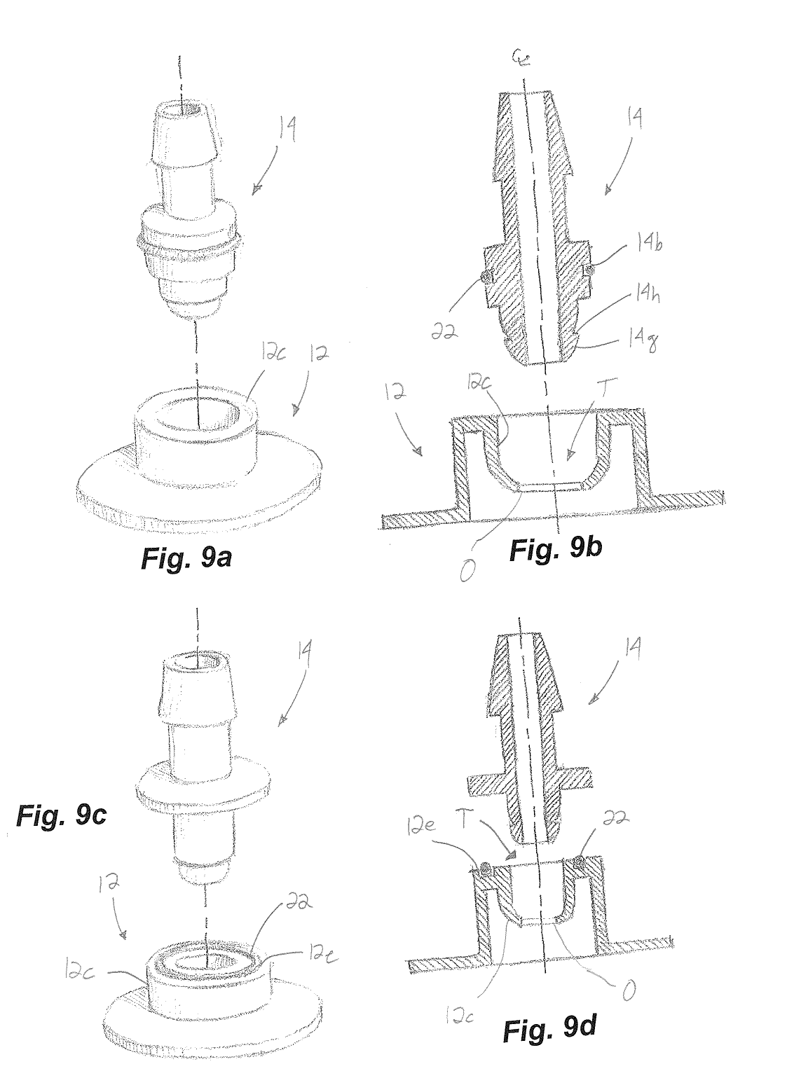

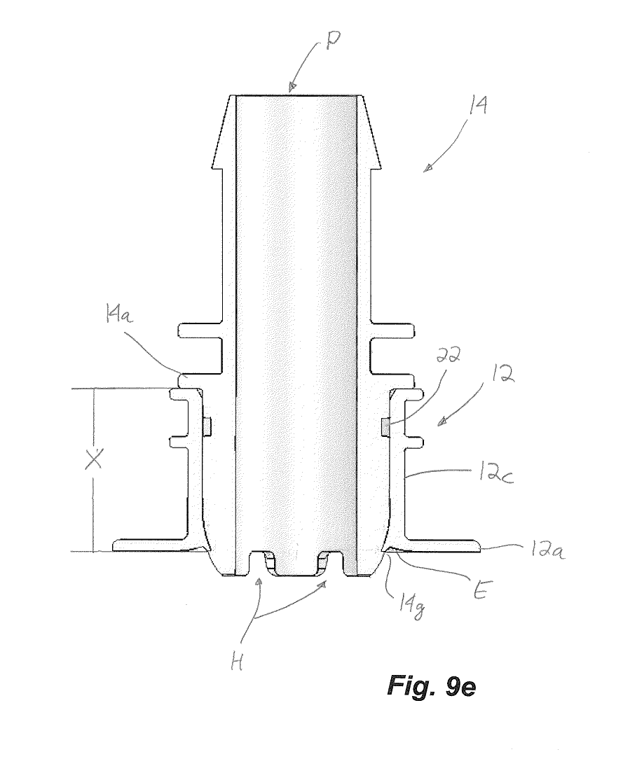

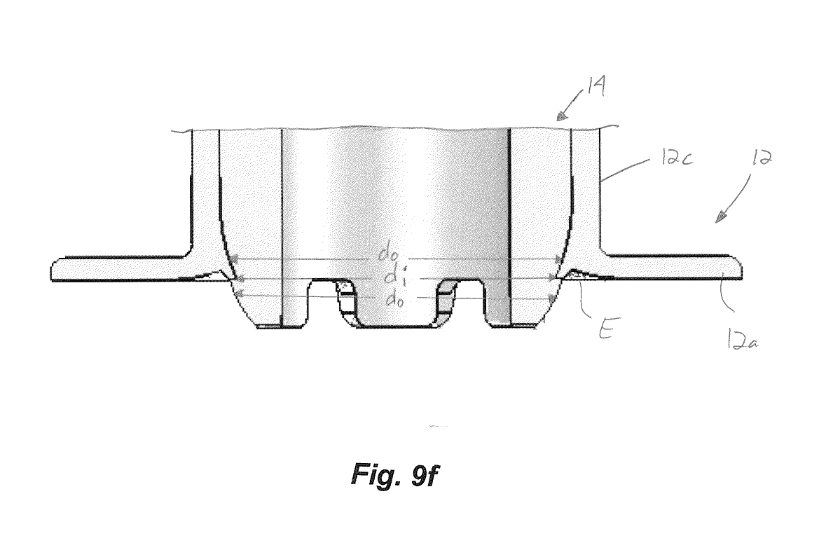

FIGS. 9a-9d illustrate embodiments conceptually similar to the one shown in FIGS. 7a and 7b in which the adapter 14 nests with the connector 12, but adapted for installation from a location external to the interior compartment I of the vessel V. Specifically, wall 12c forms a cup shaped receiver with an opening O defining a ledge for engaging a notch formed in an oversized shoulder 14g. In the embodiment of FIGS. 9a and 9b, a sealing element, such as O-ring 22, is provided in an annular groove 14b of the adapter 14. Thus, when the connector 12 and adapter 14 are in locking engagement by way of the interface between the corresponding notch 14h and ledge, the O-ring 22 contacts the inner surface of wall 12c on all sides to create a fluid-impervious radial seal that may form a sterile barrier as well.

Alternatively, a face seal may be used. For example, this face seal may be achieved as shown in FIGS. 9c and 9d by providing the sealing element, such as O-ring, along a face of the connector 12 that mates with a corresponding face of the adapter 14, such as along an outwardly directed peripheral flange. A similarly shaped, oversized groove 12e may be provided in the connector 12 for retaining the sealing element, or O-ring in the illustrated embodiment.

FIG. 9e illustrates an embodiment also conceptually similar to the one shown in FIGS. 7a and 7b in which the adapter 14 nests with the connector 12 and is adapted for installation from a location external to the interior compartment I of the vessel V. Specifically, an upstanding wall 12c forms a tubular shaped receiver with an opening O bounded by an annular shoulder 14g forming a notch for engaging an annular ledge formed by an inwardly flared lower portion of wall 12c, which preferably substantially matches the outer contour of the lower portion of the adapter 14 in shape. As can be seen in FIG. 9f, the inwardly flared portion provides the sidewall 12c with an inner diameter dᵢ that is less than an outer diameter d₀ of at least a portion of the adapter 14 (and preferably both a first portion of the adapter 14 lower than the inwardly flared portion and a second portion of the adapter 14 above the inwardly flared portion). A relief groove E, cutout, or like indentation may be provided circumferentially adjacent the interface between the wall 14c and projection 12a to enhance the flexibility of the inwardly flared portion, compared to the remainder of wall.

The adapter 14 may optionally include a peripheral projection 14a, such as an annular flange 14a, for engaging an upper portion of the wall 12c. If present, the distance between the lower surface of this projection 14a mating with the corresponding upper portion of wall 12c and the notch formed by shoulder 12g for mating with the corresponding lower portion of the wall 12c should substantially match the distance between the corresponding engagement surfaces of the adapter 14. A sealing element, such as O-ring 22, is provided in an annular groove 14b of the adapter 14.

The connector 12 may thus receive the adapter 14 from a position external to the vessel by passing it through the open end formed by wall 12c. The adapter 14 is urged to move through the interior passage such that the leading end adjacent shoulder 14g engages the inwardly flared terminal end of wall 12c, causing it to flex outwardly adjacent to the groove E. Once the shoulder 14g passes to the extent that the corresponding notch is adjacent the lower end of wall 12c, this end snaps back to engage the outer surface of the adapter 14 (and thus forms a snap-fit engagement). As should be appreciated, any further effort to advance the adapter 14 is met with resistance created between the oversized portion just above the inwardly flared lower end of the wall 12c, and any effort to remove the adapter 14 is resisted by the engagement of this end with the notch of shoulder 14g. If present, the projection 14a is in contact with the opposite end of the wall 12c, and thus further prevents any advance of the adapter 14. When the connector 12 and adapter 14 are in locking engagement by way of the interface between the corresponding notch formed by shoulder 14g and inwardly flared portion of the wall 12c, the O-ring 22 contacts the inner surface of wall 12c on all sides to create a fluid-impervious radial seal that may form a sterile barrier as well. Once engaged in this manner, the adapter 14 is locked in position in the tubular opening of the connector 12 as the result of the combined engagement at both ends in view of the matching distance X, and thus prevents any relative movement in the direction of insertion (i.e., the axial direction A). The presence of the matching portions of the inner and outer surfaces of the tubular wall 12c and the adapter 14 also prevents side-to-side movement and relative flexing between the combined parts, thereby helping to prevent inadvertent breaking of the locking engagement.

The adapter 14 in FIG. 9e projects below the lower surface of the connector 12, into the interior compartment I in use. Hence, the adapter 14 includes at least one and preferably several gaps H in the lower portion, and is thus notched or crenellated. This prevents the adapter 14 from forming a fluid-impervious seal against any adjacent surfaces of the associated vessel, such as the wall W of bag, and may also be provided with rounded or smooth edges to help prevent damage to the usually thin material of this wall. The lower portion may instead be provided with a barb or like structure for connecting with a tube inside the interior compartment I.

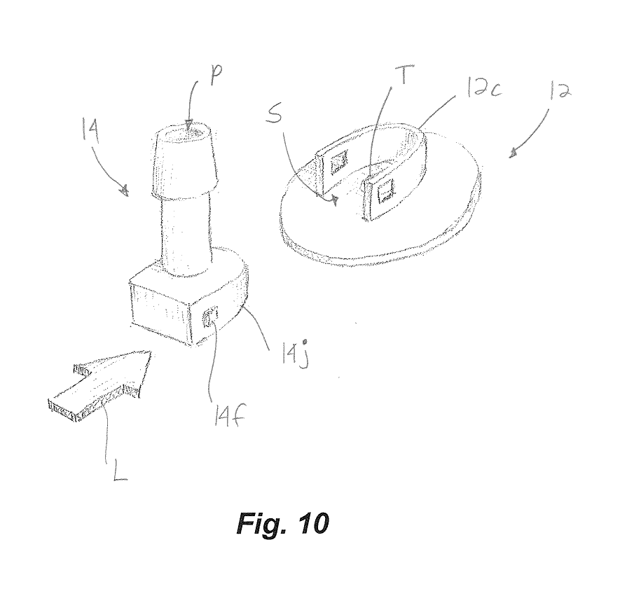

The embodiment of FIG. 10 includes a connector 12 having a wall 12c providing a top opening O exposing the port T, as well as a side opening S. A portion 14j of the adapter 14, which includes a portion of the passage P for transmitting fluid from port T, has a periphery with a contour matching the inner surface of the wall 12c. This arrangement thus allows the adapter 14 to be inserted through the side opening S in a transverse or lateral direction L, or optionally the axial direction. To form a locking engagement, peripheral locking elements may be provided on the adapter 14 and connector 12, such as tabs 14f along portion 14j adapted to engage corresponding apertures 12f in the wall 12c. In the locked condition, the arrangement is preferably such that the port T of connector 12 aligns and registers with the passage P extending through the adapter 14 to permit the desired fluid transmission.

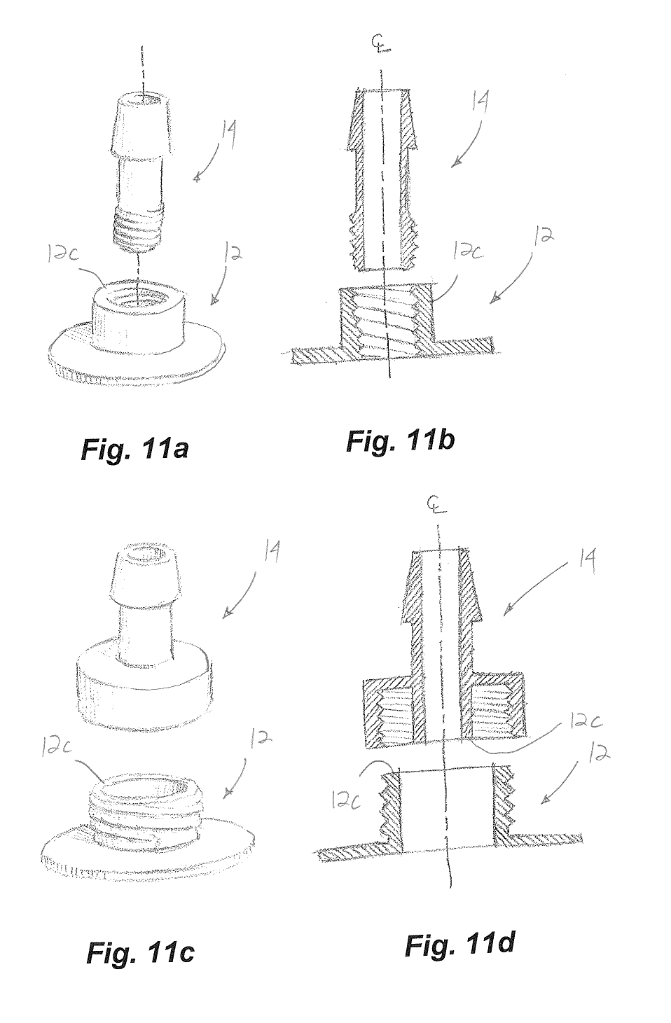

FIGS. 11a-11d depict embodiments in which the connector 12 and adapter 14 are configured for threaded engagement. In FIGS. 11a and 11b, the adapter 14 includes a peripheral locking element in the nature of a male thread for engaging a female thread along the inner surface of wall 12c of connector. The converse arrangement is shown in FIGS. 11c and 11d. In FIG. 11d, it is noted that the inner wall 14c of the adapter 14 extends into the port T, and thus may be used to connect with a structure in the interior of the vessel, such as a dip tube or the like.

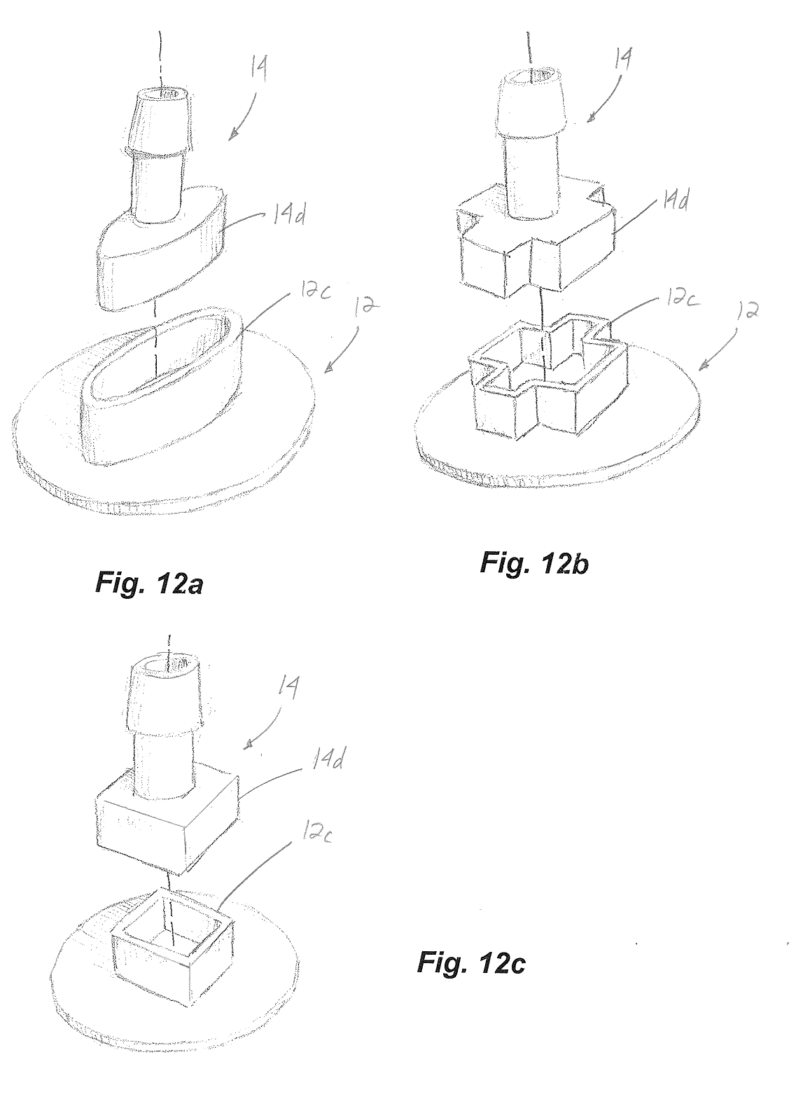

FIGS. 12a, 12b, and 12c show that the adapter 14 may include an outer wall 14d that matches with a variety of shapes of walls 12c of the connector. Thus, in FIG. 12a, the wall 12c is oval in cross-section, and wall 14d matches; in FIG. 12b, the wall 12c is cross-shaped in cross-section, and wall 14d matches; and in FIG. 12c the wall 12c is square and the wall 14d matches. As should be appreciated, the shape used is not limited to those shown, and all can benefit from any of the locking engagements described above in which relative rotation between the adapter 14 and connector 12 is not necessary to establish the connection.

The embodiments in FIGS. 13a and 13b illustrate that the connector 12 may include multiple ports, each for receiving an adapter 14. Thus, in FIG. 13a, the ports T are arranged linearly along an oblong connector 12 including a flange 12a. As should be understood, the configurability allows for different adapters 14 to be used (note the size of the center adapter as opposed to the two adapters flanking it). The ports T need not be arranged linearly, either, but may be placed in any configuration, such as the triangular arrangement of connector 12 with a corresponding flange 12a shown in FIG. 13b.

The adapters 14 may be different in the sense that they include different types of locking elements for associating with the connector 12 with the various ports T, which may include corresponding locking elements, if desired. Thus, one adapter 14 may includes a first type of locking element, such as for example the one shown in FIG. 6a, and a second adapter may include a second, different locking element, such as the one shown in FIG. 5b. The connectors 12 may be the same, or may be adapted to correspond to the different locking elements. With this specific type of arrangement, in which only certain of the adapters correspond to certain of the ports T in the multi-port connector 12, it can be assured that a particular type of adapter mates with one of the ports T in a pre-determined arrangement.

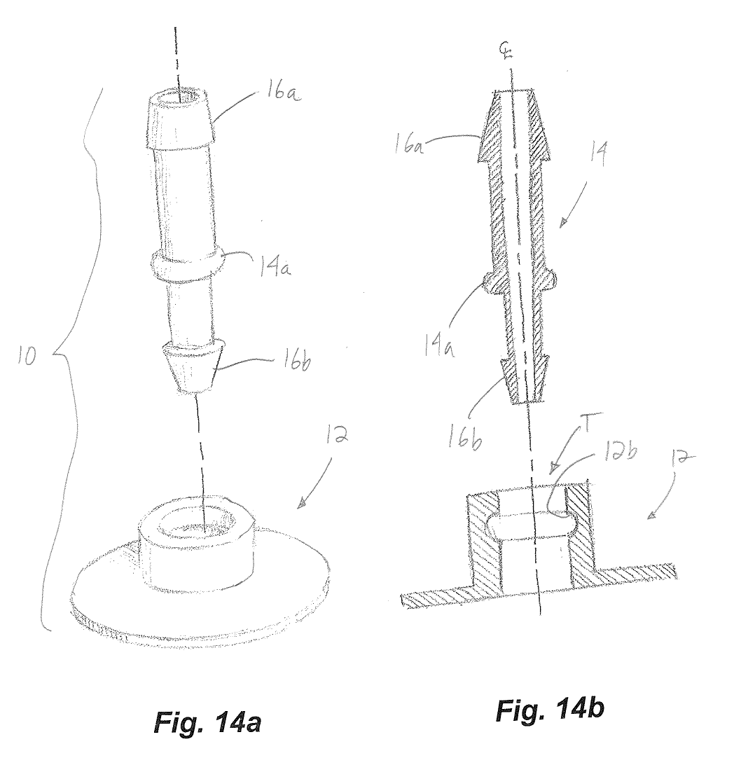

FIGS. 14a and 14b show a connector 12 and adapter 14 with corresponding locking elements (such as a projection 14a in the form of annular bead for engaging a corresponding recess 12b) to form the desired engagement and allow for selective reconfiguration. In this particular arrangement, the adapter includes not only a first coupler for engaging a structure outside of the vessel (such as a length of tubing), but also a second coupler for engaging a structure inside the vessel (not shown). For example, in the illustrated embodiment, the adapter 14 includes a first barb 16a adjacent one end and a second barb 16b adjacent another end, which will be positioned within the port T or vessel when the locking engagement is established between the bead 14a and recess 12b. As can be appreciated, the two couplers (e.g., barbs 16a, 16b) may be of different size and shape to accommodate different structures, such as tubes having different diameters.

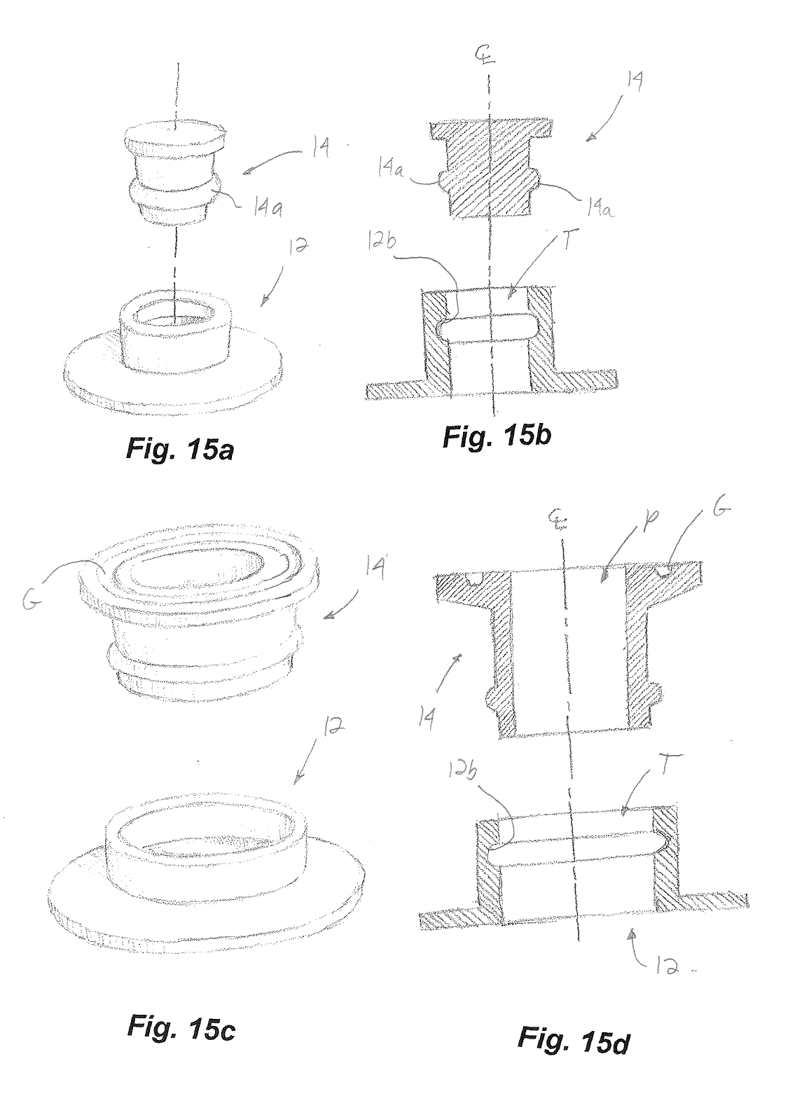

FIGS. 15a-15d show that the concepts described herein may be applied to structures other than an adapter 14 with a tubular passage P and at least one barb 16. Thus, as shown in FIGS. 15a and 15b, the adapter 14 may take the form of a valveless closure or plug for sealing the port T. The locking engagement may be established using any of the means described, and in the illustrated embodiment takes the form of an annular bead as projection 14a for engaging a corresponding annular recess 12b in the connector. Likewise, FIGS. 15c and 15d show a similar locking arrangement in use with an adapter 14 including an oversized passage P used for charging the vessel with powder, such as from an external source (typically a bag) and a face groove G for mating with a sealing element for associating with a corresponding clamp or the like.

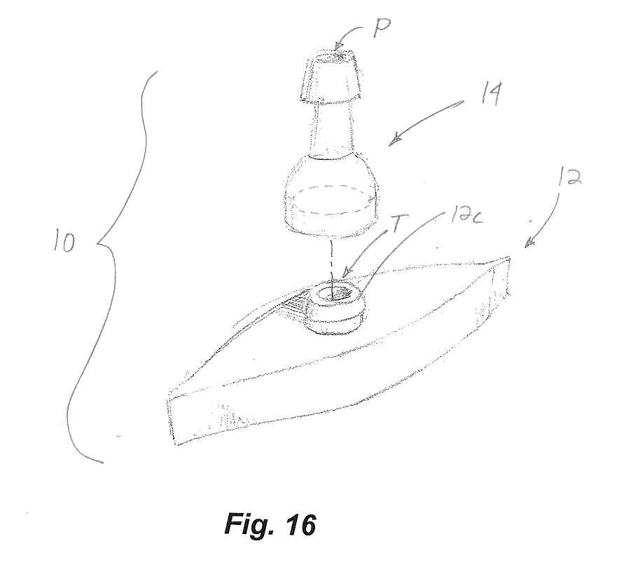

Any of the concepts described above may also be used to create a boat fitment 10, as shown in FIG. 16. Here, the connector 12 comprises a boat-shaped structure, but may still include the upstanding wall 12c forming port T. In the particular embodiment illustrated, the adapter 14 includes an internal ledge (note dashed line along passage P) for mating with a corresponding oversized ledge formed on the upper end of the wall 12c in a snap-fit engagement. However, it should be appreciated that any of the above-described arrangements for forming the locking engagement may be used to form a boat-shaped fitment.

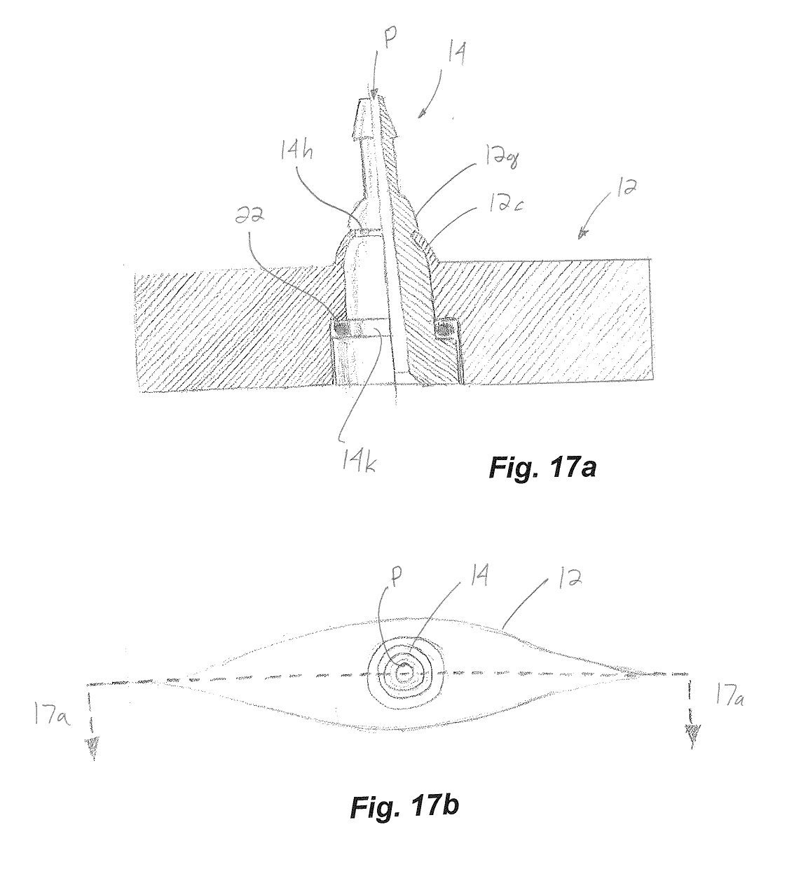

FIGS. 17a and 17b show a boat-shaped fitment 10 in which the connector 12 includes a wall 12c forming a ledge for engaging a notch 14h of the adapter 14, which is provided an oversized shoulder 12g. In this embodiment, the port T formed by the connector 12 matches the outline of a portion of the adapter 14 received in it when the two structures are nested. A sealing element, such as O-ring, may be provided, and held by a corresponding groove 14k in the nested portion of adapter 14.

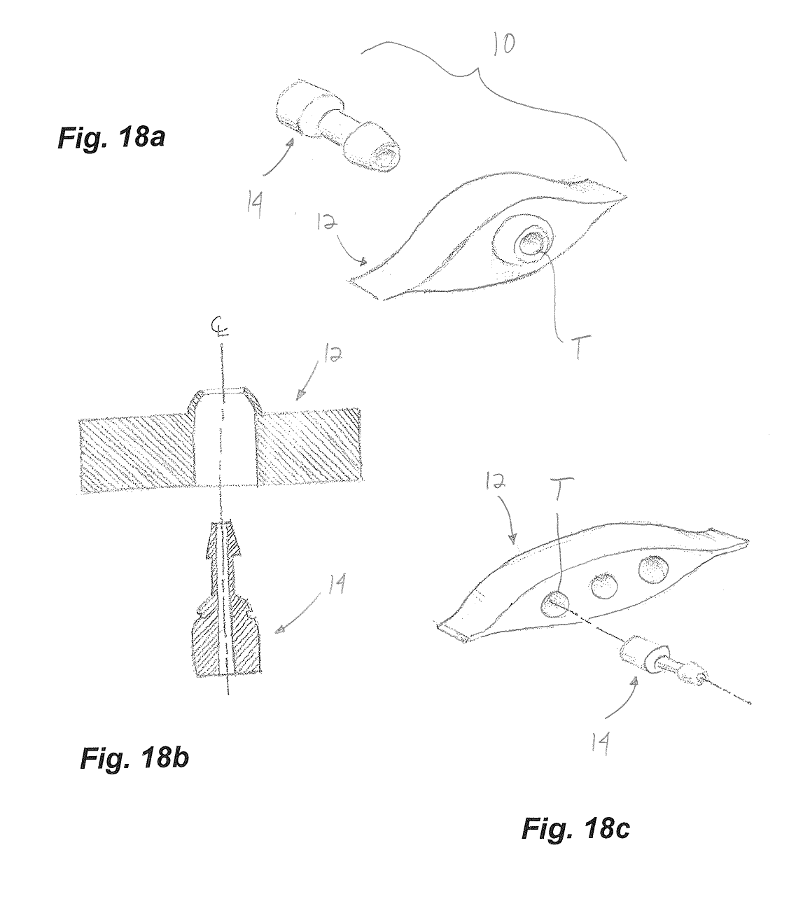

As should be appreciated, the boat-shaped fitment 10 may comprise a connector 12 with a single port T, as shown in FIGS. 18a and 18b. Alternatively, as shown in FIG. 18c, the connector 12 may comprise multiple ports T, each adapted for receiving one of a plurality of different adapters having matching locking elements. The ports T may be arranged linearly, as shown, or otherwise.

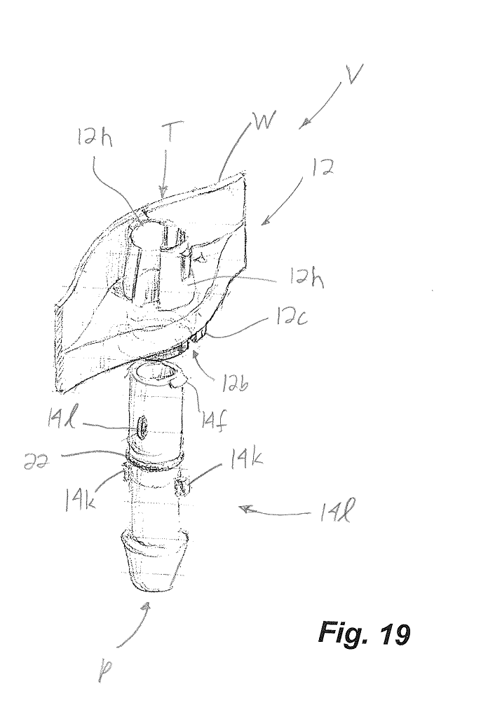

FIG. 19 shows an alternate embodiment of a boat-shaped fitment 10 including a connector 12 having a port T and for use with one of a plurality of different adapters arranged to mate with the connector in locking engagement. In the illustration, the wall W of the vessel adjacent the fitment 10 is shown, but the opposite wall is removed for purposes of clarity. From this view, it can be understood that the connector 12 includes a wall 12c includes recesses 12b in the form of a pair of slots sized to receive alignment tabs 141 on the adapter. The adapter 14 further includes opposed peripheral projections in the form of tabs 14f that engage a corresponding structure in the interior of the vessel, such as a ledge formed by pair of opposed, generally curved walls 12h forming a frusto-conical structure.

Thus, when the adapter 14 is installed, the alignment tabs 12b ensure that the tabs 14f serving as locking elements engage the walls 12h to form the desired locking engagement. This engagement tends to flex the walls 12h, so one or more strengthening ribs may be provided. If desired, fluid may freely flow through passage P via port T, as in the other embodiments. Additionally, the gaps between the walls 12h allow fluid to also flow from an adjacent space through a side drain 141 in the adapter 14 communicating with passage P. A sealing element, such as O-ring 22, may also be provided along the adapter 12 for engaging an inner surface of the connector 12 along port T.

FIGS. 20a-20c illustrate a port fitment comprising a single connector 12 providing a plurality of upstanding structures 30a-30n forming ports T, each for receiving an adapter (not shown). The base of the connector 14 comprises an oblong flange. The adapters used may of course be the same or different in design, and may be of the type shown in FIG. 9e so as to form a locking snap-fit engagement with a portion of the adapter engaging a seating surface of the structures 30a-30n and a second portion extending below the lower surface of the connector 12 and into the interior compartment of the corresponding vessel. The structures 30a-30n may be interconnected by connectors 32. Along the side facing the interior compartment I of the vessel V in use, projections 34 may also be provided to help prevent adherence between the corresponding surface of the connector 14 and a surface of the vessel V.

In accordance with another aspect of this disclosure, a plurality of different adapters are configured to establish a locking engagement with a connector, may be provided as part of a kit for configuring a vessel including the connector. The adapters may, for example, comprise tubular structures with passages and include one or more couplers, such as barbs 16, having different sizes or shapes (see FIGS. 1c and 1d). The locking engagement may be of the various types described and shown, including a snap-fit engagement, a threaded engagement, and a bayonet fitting. In non-sterile applications, this type of engagement may also allow for one type of adapter to be quickly disconnected and substituted for a different one, depending on the application to which the vessel V is put.

The kit including different adapters may thus be provided, along with a supply of vessels (such as bags), each with a connector adapted to form a locking engagement with the different adapters. Preferably, the adapters are different in the sense of their ability to couple with the open ends of different sizes of tubing, but may also be different in the type of locking element included. The kit may also include different adapters for engaging multiple ports in a single connector 12, as shown in FIGS. 13a-13c. Most preferably, each different adapter 14 includes a tubular passage for transmitting fluid to or from the interior compartment I, but could also have a closed end for blocking one of the ports that is not to be used.

When an order is placed, the supplier may associate the desired adapter(s) with one or more connector(s) of the vessel to meet the particular needs or demands of the customer. Advantageously, the need for forming the fitment 10 using cumbersome, time-consuming, and relatively costly precision manufacturing techniques, such as heat or ultrasonic welding, may be avoided. Furthermore, it becomes unnecessary to store a plurality of specially adapted vessels until an order is made, since the demand can be filled in a custom fashion just-in-time for delivery. This lack of any requirement for storing a more significant inventory of pre-sterilizing, pre-manufactured vessels than might be presently demanded may reduce warehousing and tracking costs. The resultant shorter manufacturing time and the lack of involved techniques also help to ensure that the integrity of the vessel is maintained and thus may also reduce the incidence of testing for this purpose.

For certain of the embodiments described herein (including for instance those of FIGS. 1, 2, 5, 6, 7, 8 and 9), it is contemplated that one or both of the locking elements may be formed in a frangible manner, such that disengagement causes permanent deformation that prevents the secure locking engagement from being re-established. This advantageously prevents re-use of the adapter and connector to form the locking engagement a second time. It has also been discovered that the process of sterilization using irradiating energy, such as gamma rays, causes the plastic material used to form the adapter 14 (such as high density polypropylene in the most preferred embodiment, but also polypropylene, EVA, LDPE, LLDPE, etc.) to become more brittle than prior to irradiation. Hence, when the adapter 14 is placed in the connector 12 and then made more brittle, its subsequent removal may cause significant deformation or perhaps even breakage of the material, which then helps to prevent the adapter from being inadvertently reused.

Related methods are also described for use in forming a vessel with a port fitment 10. For example, a method for forming a vessel may comprise associating a selected connector including a port with one of a plurality of different adapters having tubular passages and each configured to establish a locking engagement with the connector. As described above, the associating step may comprise establishing the locking engagement between the one adapter and the connector. A related method for adapting one of a plurality of vessels, each including at least one connector having a port, comprises providing a plurality of different adapters, each matching the at least one connector of the plurality of vessels. The method may instead comprise selecting one of a plurality of different adapters corresponding to a connector on the vessel, the connector including a plurality of ports, and associating the selected adapter with the connector. Alternatively, the method may comprise associating a plurality of different adapters with a plurality of ports of the vessel.

The foregoing descriptions of various embodiments of the present inventions have been presented for purposes of illustration and description. These descriptions are not intended to be exhaustive or to limit the invention to the precise forms disclosed. The embodiments described provide the best illustration of the principles of the invention and its practical applications to thereby enable one of ordinary skill in the art to utilize the invention in various embodiments and with various modifications as are suited to the particular use contemplated.

1. An apparatus for forming a port fitment, comprising:
an unsterilized vessel having an interior compartment adapted for receiving a fluid, said vessel including a connector having a first wall bounding a port and including a first locking element; and
a first adapter including a first end portion adapted for insertion in the interior of the first wall, said first adapter having a passage adapted for transmitting the fluid to or from the vessel via the port and a second locking element adapted for forming a locking engagement with the first locking element of the connector.

2. The apparatus of claim 1, wherein the port comprises a tubular passage, and the first and second locking elements form the locking engagement within the tubular passage.

3. The apparatus of claim 1, further including a second adapter having a third locking element adapted for forming a locking engagement with the first locking element of the connector.

4. (canceled)

5. The apparatus of claim 1, wherein the first locking element comprises at least one projection and the second locking element comprises a receiver.

6. The apparatus of claim 1, wherein the first locking element comprises a receiver and the second locking element comprises at least one projection.

7. The apparatus of claim 6, wherein the projection comprises an annular bead for engaging the receiver in snap-fit engagement.

8. The apparatus of claim 1, wherein one of the first or second locking elements comprise one of at least two projections and at least two receivers.

9. The apparatus of claim 8, wherein the projections comprise lugs and the receivers comprise channels.

10. The apparatus of claim 8, wherein at least one of the channels comprises at least one segment extending in an axial direction along the connector and at least one segment extending in a circumferential direction along the connector, whereby the lug and channel create a bayonet fitting.

11. The apparatus of claim 8, wherein the at least two projections of the first locking element comprise flexible arms, each having an end adapted for positioning in one of the receivers.

12. The apparatus of claim 8, wherein the at least two projections of the second locking element comprise arms projecting axially from a peripheral ledge of the connector.

13. The apparatus of claim 8, wherein the first locking element comprises a removable fastener and the second locking element comprises an aperture for receiving the fastener.

14. The apparatus of claim 8, wherein the first locking element comprises a cup-shaped receiver including an opening defining a ledge, and the second locking element comprises a shoulder having a periphery oversized relative to the opening and forming a notch for engaging the ledge.

15. The apparatus of claim 1, wherein the first locking element comprises an inwardly flared flexible projection depending from the first wall and the second locking element comprises a shoulder having a periphery oversized relative to the opening and forming a notch for engaging the projection.

16. The apparatus of claim 15, wherein the adapter includes a peripheral projection for engaging an upper surface of the first wall when the notch engages the projection.

17. The apparatus of claim 1, wherein the first locking element comprises a thread and the second locking element comprises a matching thread.

18. The apparatus of claim 1, further including a first barb on a first end of the adapter and a second barb on a second end of the adapter.

19. The apparatus of claim 18, wherein the first and second barbs are adapted for engaging different sizes of tubing.

20. The apparatus of claim 1, wherein the first wall of the connector includes a side opening and a top opening exposing the port.

21. The apparatus of claim 20, wherein the adapter is configured for insertion through the side opening of the first wall.

22. The apparatus of claim 21, wherein the adapter comprises a tubular passage communicating with a side drain adapted to receive fluid from a space formed by the first wall.

23. The apparatus of claim 21, wherein the adapter comprises at least one alignment tab for engaging the side opening in the first wall.

24. The apparatus of claim 21, wherein the at least one alignment tab is offset from the first locking element in a circumferential direction.

25. The apparatus of claim 21, wherein the wall is frusto-conical and projects towards an interior compartment of the vessel.

26.-31. (canceled)

32. The apparatus of claim 1, wherein the connector includes a plurality of ports, and further including an adapter for engaging each of said ports.

33. The apparatus of claim 32, wherein at least three ports form a substantially linear row.

34. The apparatus of claim 1, wherein the adapter includes crenellations.

35.-52. (canceled)

53. An apparatus for forming a port fitment on a vessel having an interior compartment, comprising:
a connector adapted for connection to the vessel, said connector having an elongated, generally upstanding sidewall forming a tubular port and including an inwardly flared, flexible projection; and
a first adapter including a first portion adapted for insertion in the interior of the tubular port and having an oversized shoulder adapted for engaging the inwardly flared, flexible projection of the connector.

54. (canceled)

55. An apparatus for forming a port fitment on a vessel, comprising:
a connector adapted for connection to the vessel, said connector having an elongated, generally upstanding sidewall forming a tubular port including a first locking element; and
a first adapter including a first portion adapted for insertion in the interior of the tubular port and a second, generally concentric second portion, said first and second portions forming a receiver, and one of said first or second portions including a second locking element for forming a locking engagement with the first locking element of the connector.

56. An apparatus for forming a port fitment, comprising:
a vessel having an interior compartment adapted for receiving a fluid under sterile conditions, said vessel including a connector having a first locking element; and
a first adapter including a second locking element connected to the first locking element of the connector to form a locking engagement, such that breaking the locking engagement deforms one or the first or second locking elements in a manner that prevents use under sterile conditions.

57. (canceled)

58. A kit for forming a port fitment on a vessel including a connector having a generally upstanding sidewall forming a tubular port and including first locking element, comprising:
a plurality of tubular adapters, each including a first portion adapted for insertion in the interior of the tubular port and including a second locking element for forming a locking engagement with the first locking element of the connector.

59. (canceled)

60. A method of forming a sterilized vessel for an end user, comprising:
providing an unsterilized vessel including a connector having a port and including a locking engagement between a first locking element of the adapter and a second locking element of the connector, such that, upon disengagement, one of the adapter or the connector cannot form the locking engagement again; and
prior to delivery to the end user, sterilizing the vessel with the adapter associated with the connector.

61. The method according to claim 60, wherein the connector includes a plurality of ports, and further including the step of positioning a different adapter in each port of the connector.

62. (canceled)
